(19) United States
(12) Patent Application Publication
(10) Pub. No.: US 2011/0250038 A1
(43) Pub. Date: Oct. 13, 2011

(54) DRIVE OVER BULKWEIGHER TRANSLOAD SYSTEM

(75) Inventor: Sheldon Affleck, Regina (CA)

(73) Assignee: Mobil Grain Ltd., Regina (CA)

(21) Appl. No.: 13/082,665

(22) Filed: Apr. 8, 2011

(30) Foreign Application Priority Data
Apr. 8, 2010 (CA) 2699365

(51) Int. Cl. B65G 69/00; B65G 67/00; G01G 19/00

(52) U.S. Cl. 414/21; 414/800

(57) ABSTRACT

A system and method for weighing and loading particulate material while the particulate material is passing through the system is provided. The system can include a roadway, an opening positioned in the roadway and at least one bulkweigher provided below the opening. A rail car or a trailer can be positioned above the opening in the roadway and particulate material discharged from the rail car or trailer through the opening into the at least one bulkweigher. The bulkweigher can weigh the particulate material as it is being discharged and, after the particulate material has been weighed by the at least one bulkweigher, the bulkweigher can discharge the particulate material onto a conveyor to be loaded into another rail car or trailer.

This invention is in the field of transloading systems for transferring crop material from a truck and trailer/railroad car to another railroad car and more particularly a transloading system that weighs the crop material as it is being moved by the transloading system and loaded into the railroad car.

### BACKGROUND

Grain and other crop materials are often sold to a market that is far from where the crop is first grown and harvested. Frequently, the first stage in transporting this crop to its eventual destination is to transport the crop material by truck to a grain elevator located near the point of harvest. A grain elevator is a large building containing a number of large bins or other storage facilities that receives smaller loads of crop material from the producer, stores the crop material in bulk in one or more of the bins and then loads the crop material into a railroad car or other means of conveyance when the crop material is ready to be transported over the next stage of its journey to its final destination.

After a producer (i.e. farmer) grows and harvests his or her crop, he or she will typically transport this crop material by truck to a nearby grain elevator. At the grain elevator, the producer will often have his or her truck weighed on a scale with the load of crop material still on the truck. The producer will then drive his or her truck to another location at the grain elevator where the truck is unloaded. This unloaded crop material is usually transported, divided and distributed inside the grain elevator where it will eventually be moved to one of a number of bins for storage until it is ready to be loaded onto a railcar or other means of transportation to its next destination. With the crop material unloaded, the producer will then drive the truck to be reweighed on a scale with the crop material unloaded. The weight of the crop material unloaded by the producer at the grain elevator is then approximated by taking the weight of the truck with the crop material on board and subtracting the weight of the unloaded truck.

The crop material unloaded by the producer will be stored in a bin or bins with other crop material from other producers until it is loaded in a railroad car or other conveyance means to be transported to its next destination, such as an ocean port to be loaded on a freight and shipped overseas, etc. To load the stored crop material into a railroad car or other means of conveyance, the stored crop material is removed from its storage bin and typically moved to an elevated bin where it is once again weighed and then loaded into a railroad car for shipment.

However, using a grain elevator is not always desirable. Grain elevators require large capital costs to construct the buildings, bins, grain handling equipment, etc. that are needed therefore requiring the grain elevator to be placed in a location with direct access to a lot of crop producers that will deliver their crop material to the grain elevator. The grain elevators also store the grain in a bulk format requiring large amounts of crop material to be stored in the bins in the grain elevator and the numerous steps involved in moving and transporting the crop material inside the grain elevator itself can damage the crop material and reduce the quality of the crop material. This is especially true for lentils, peas, etc. The capacity of the grain elevator is also relatively fixed. It is constructed to store a certain amount of grain and this storage capacity cannot be easily increased or decreased as needed.

Additionally, the large amounts of crop material needed by a grain elevator and their bulk storage of these crop materials in bins at the grain elevator can prevent the identity preservation (IP) of the crop material being stored in the grain elevator. Identity preservation of crop material is a relatively recent idea where the integrity and purity of crop material is maintained by carefully maintaining the separation of the crop materials and tracking their progress through transportation to their final destination. This is done for crop materials with unique traits such as non-genetically modified crop material, special types of a specific crop, organic crop material, etc. To preserve the identity of the crop material, the crop material coming from different producers must be kept separated and free from contamination by other crop materials, as well as requiring the crop material to be tracked through its transportation to its end destination. However, the bulk storage of crop material in grain elevators while the crop material is waiting to be loaded into a railroad car or other means of conveyance can make identity preservation very difficult if not impossible in a grain elevator setting.

An alternative to unloading at a grain elevator is to have a producer unload their crop material directly into a railroad car for either temporary storage in the railroad car or to be transported to the next destination. While this does eliminate the infrastructure needed for a grain elevator it does have its own problems. Ideally, the railroad cars have to be loaded quickly and efficiently to prevent excessive delays in loading the railroad cars.

### SUMMARY OF THE INVENTION

In one aspect, a system for weighing and loading particulate material while the particulate material is passing through the system. The system comprises: a roadway; an opening positioned in the roadway; at least one bulkweigher provided below the opening, the at least one bulkweigher having an outlet; and a conveyor having an intake end and a discharge end, the intake end of the conveyor positioned below outlet of the bulkweigher to receive particulate material that has been weighed by the bulkweigher and discharged from the bulkweigher.

In another aspect, a system for weighing and loading particulate material while the particulate material is passing through the system. The system comprises: a roadway; an opening positioned in the roadway; a plurality of bulkweighers positioned below the opening and a garner connected to the opening, the garner positioned to direct particulate material discharged through the opening to the plurality of bulkweighers, bulkweigher having an outlet; and a plurality of conveyors, each conveyor associated with one of the bulkweighers so that a discharge end of the material conveyor is positioned below the outlet of the associated bulkweigher to receive particulate material that has been weighed by the bulkweigher and discharged from the bulkweigher.

In another aspect, a method of simultaneously weighing and loading particulate material. The method comprises the steps of: providing a roadway positioned above at least one bulkweigher; providing an opening in the roadway; positioning one of: a rail car; and a trailer above the opening in the roadway and discharging the particulate material through the opening into the at least one bulkweigher; weighing the particulate material with the at least one bulkweigher as it is being discharged; and after the particulate material has been weighed by the at least one bulkweigher, discharging the particulate material onto a conveyor and using the conveyor to load the particulate material into at least one of: an other railcar; and an other trailer.

In one aspect, a transload system can be provided. The transload system can include a trestle bridge for receiving a truck and trailer/railroad car and supporting the truck and trailer/railroad car over top of a plurality of bulkweighers. A garner can be provided connected to an opening in the trestle bridge for directing crop material that has been discharged from the truck and trailer/railroad car into one of the bulkweighers. The bulkweighers can be used to weigh a batch of crop material before discharging the batch of crop material into an intake end of a conveyor positioned beneath the bulkweigher and accepting another batch of crop material to be weighed. The plurality of conveyors can convey the crop material discharged from the bulkweighers to be loaded into an adjacent railroad car. The transload system can be used to simultaneously weigh the crop material and load it into an adjacent railroad car.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of a transload system for simultaneously unloading, weighing and loading crop material;

FIG. 2 is a perspective view of the transload system of FIG. 1 shown unloading a truck and trailer;

FIG. 3 is a perspective view of the transload system of FIG. 1 shown unloading a railroad car;

FIGS. 4A and 4B are perspective views of the transload system of FIG. 1 enclosed in a building;

FIG. 5 is a perspective view of a trestle bridge forming part of the transload system shown in FIG. 1; and

FIG. 6 illustrates a side schematic view of the transload system.

### DETAILED DESCRIPTION OF THE ILLUSTRATED EMBODIMENTS

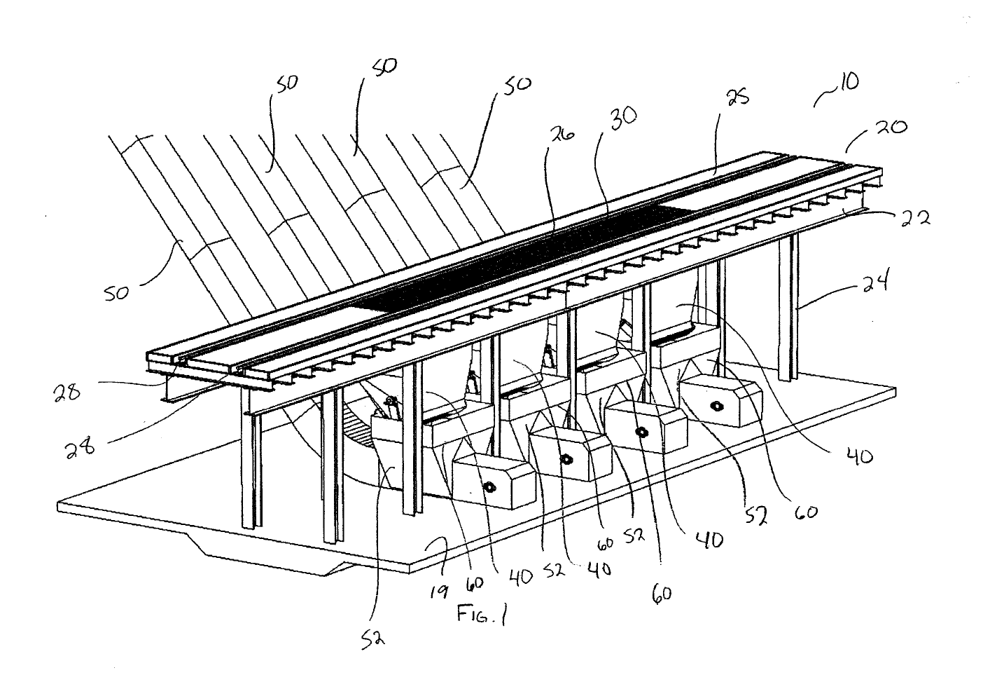

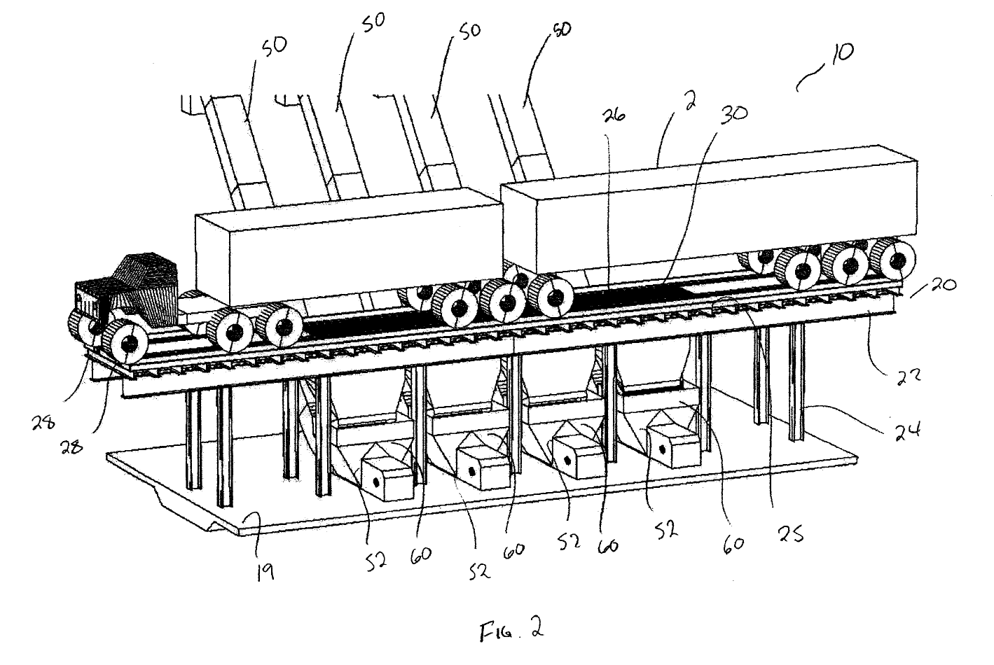

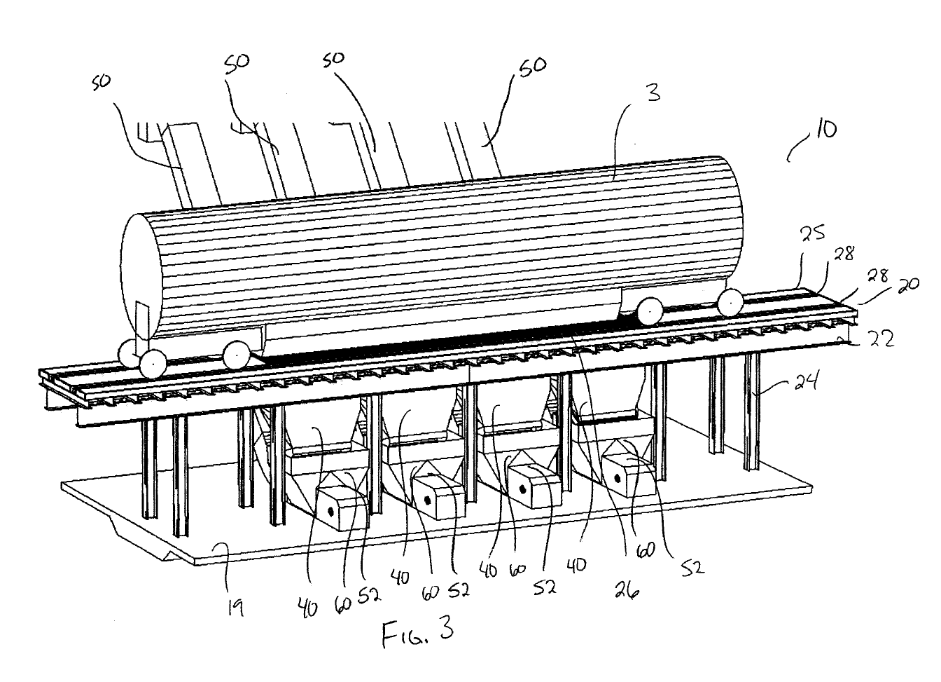

FIGS. 1-3 illustrate a transload system 10 for emptying a truck or railroad car into another truck or railroad car. A truck or railroad car can discharge its load of flowable particulate material into the transload system 10 where it will be weighed and conveyed into a railroad car on a railroad track positioned adjacent to the transload system 10. The particulate material can be any type of flowable granular product such as crop material (e.g. grain, lentils, peas, etc.), fertilizer, feed pellets, etc. In this manner, a load of crop material on a truck and trailer 2 can be weighed while it is being unloaded from the truck and trailer 2 and loaded into an adjacent railroad car for temporary storage and/or transport, as shown in FIG. 2. Additionally, the transload system 10 could also be used to unload crop material from one railroad car 3 to another railroad car, as shown in FIG. 3.

The transload system 10 can include: a trestle bridge 20 for receiving a truck 2 or railroad car 3 and supporting it over top of a plurality of bulkweighers 40; a garner 30 for directing crop material discharged from the truck or railroad car into one of the plurality of bulkweighers 40; and a plurality of conveyors 50 for receiving crop material after it has been weighed by one of the bulkweighers 40 and transporting the received crop material upwards for loading into an adjacent railroad car or other means of conveying the crop material. The transload system 10 can weigh the crop material being discharged from the truck 2 or railroad car 3 while it is being discharged and conveyed to the other railroad car causing the weight of the load of crop material to be known almost as soon as the truck 2 or railroad car 3 is finished being unloaded.

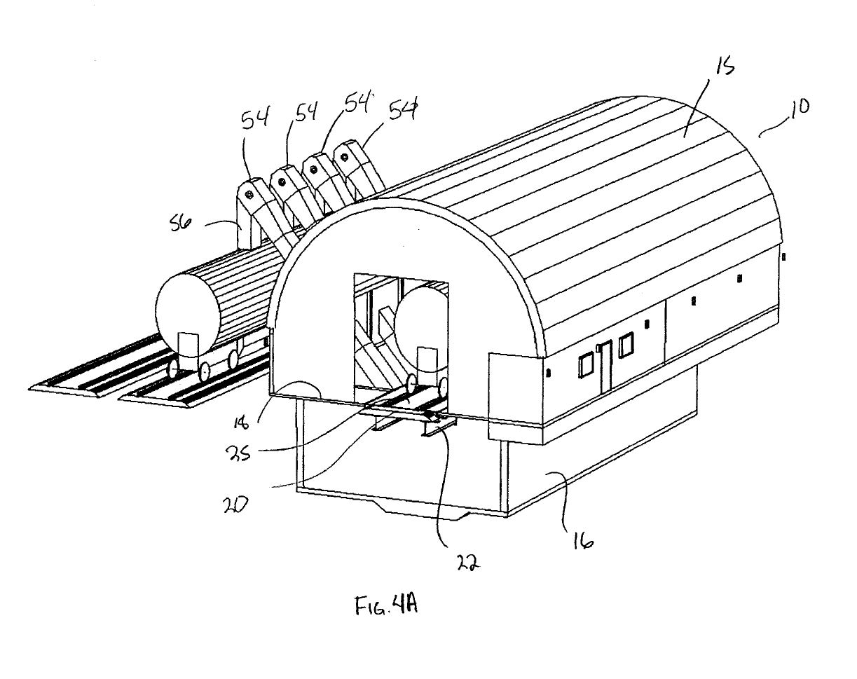

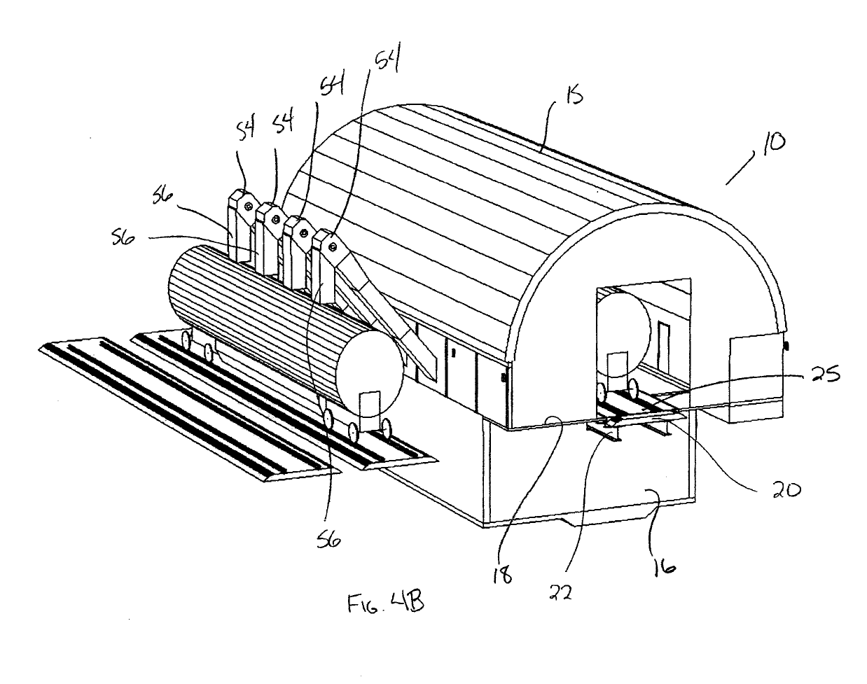

FIGS. 4A and 4B illustrate the transload system 10 covered by a building 15 to protect the components of the system 10 from the elements. A pit 16, such as a concrete pit, can be provided to contain the bulkweighers 40 and other components of the transload system 10 below a ground surface 18.

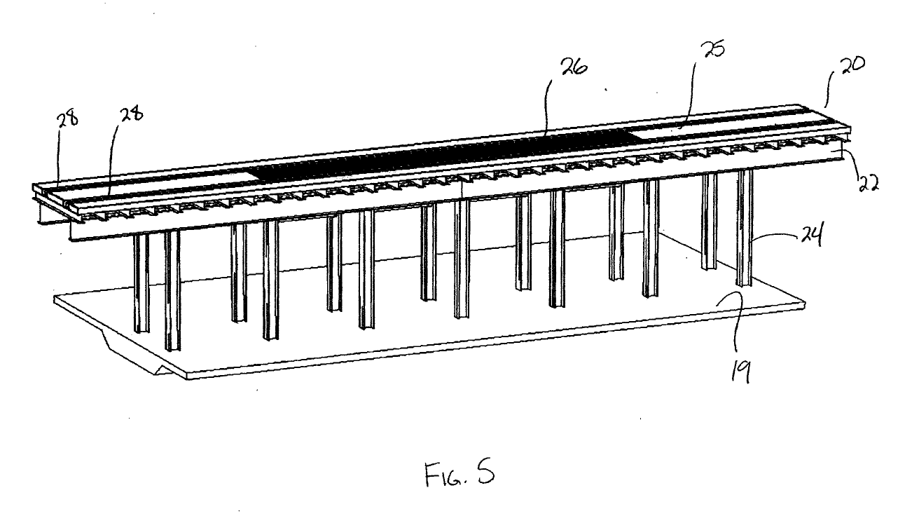

FIG. 5 illustrates the trestle bridge 20. The trestle bridge 20 can be supported by beams 22 and a number of support posts 24 to support a roadway 25 overtop of the bulkweighers 40 and intake ends 52 of the conveyors 50. The support posts 24 can be positioned on a floor 19 of the pit 16 to support the trestle bridge 20. The roadway 25 and trestle bridge 20 can be provided with an opening 26 passing through it to the garner 30. The roadway 25 can be provided at a same level as a ground surface 18 so that trucks and trailers can be driven directly onto the roadway 25 from the ground surface 18. The beams 22 and support posts 24 are chosen so that the roadway 25 and trestle bridge 20 can support the weight of a loaded truck and trailer parked on the roadway 25 over top of the garner 30, bulkweighers 40 and the inlet ends 52 of the conveyors 50 contained in the pit 16.

The opening 26 can be positioned in the roadway 25 and the trestle bridge 20 to correspond to outlets on the trailer to be unloaded, allowing a truck operator to drive a truck and trailer 2 loaded with crop material onto the roadway 25 (as shown in FIG. 2) and position the trailer 2 so that an operator of the truck and trailer 2 can simply open the hopper gates on the trailer 2, dumping the crop material through the opening 26 and into the garner 30 to be weighed and loaded into an adjacent railroad car using the transload system 10.

The roadway 25 can also have recessed railroad tracks 28 provided in the surface of the roadway 25 so that a railroad car 3 can be moved onto the roadway 25 using the tracks 28. The transload system 10 can then be used to unload crop material from the railroad car 3 and weigh the crop material before loading the crop material into an adjacent railroad car.

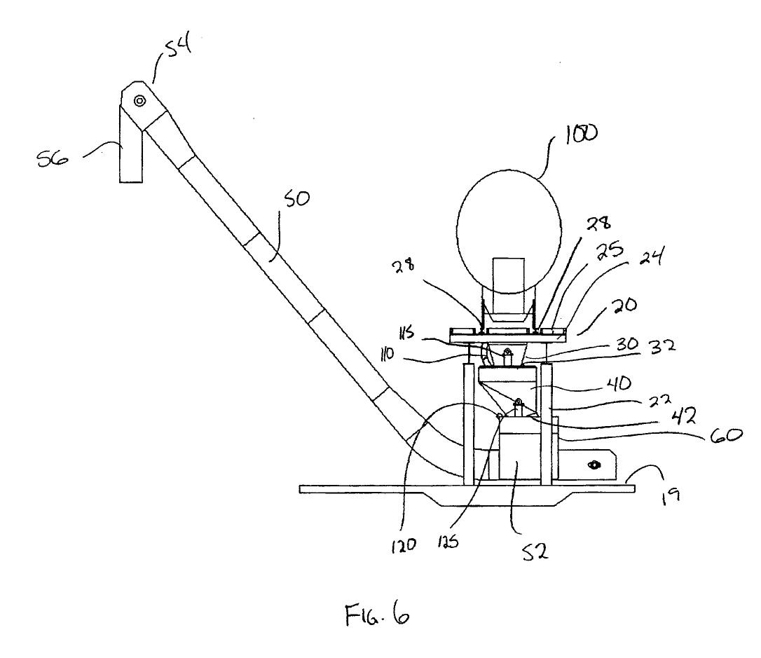

FIG. 6 illustrates one of the plurality of bulkweighers 40 positioned beneath the garner 30 for weighing crop material being unloaded from a trailer/railroad car 100 positioned on the roadway 25 of the trestle bridge 20.

Each bulkweigher 40 is positioned below the trestle bridge 20 so that crop material discharged from the trailer/railroad car 100 into the garner 30 can fed by gravity into one of the bulkweighers 40. Referring to FIG. 1, each conveyor 50 is associated with a single bulkweigher 40 such that the intake end 52 of the conveyor 50 is positioned below its associated bulkweigher 40 so that crop material that is discharged from the bulkweigher 40 after it has been weighed is directed into the intake end 52 of the conveyor 50.

Each bulkweigher 40 operates by receiving a load of crop material from the garner 30 which is then weighed by the bulkweigher 40. Once the bulkweigher 40 has weighed the crop material, the crop material is discharged from the bulkweigher 40 into the intake end 52 of the conveyor 50 positioned beneath the bulkweigher 40 and another load of crop material is discharged into the bulkweigher 40 from the garner 30.

A first gate 110 can be provided to selectively open and close an outlet 32 of the garner 30. The first gate 110 can be a slide gate, clam gate, etc. This first gate 110 can be moved between a closed position where the first gate 10 covers the outlet 32 of the garner 30 preventing substantially any crop material from being discharged from the garner 30 and into the bulkweigher 40 and an open position where the first gate 110 is moved out of the way of the outlet 32 of the garner 30 so that crop material can flow from the garner 30 into to the bulkweigher 40. This first gate 110 can be provided on a pivot arm 112 so that the first gate 110 is pivoted on the arm 112 between the open position and the closed position.

In one aspect, the first gate 110 can be pivoted to the open position such that the first gate 110 is positioned substantially vertically causing any crop material that has collected on top of the first gate 110 to fall into the bulkweigher 40. In this manner, the first gate 110 can be self cleaning, preventing any crop material from one load remaining on top of the first gate 110 and mixing and potentially contaminating a later load of crop material.

A second gate 120 can be provided to selectively open and close an outlet 42 of the bulkweigher 40. The second gate 120 can be a slide gate, clam gate, etc. The second gate 120 can be selectively positionable between a closed position and an open position. In the closed position, the second gate 120 can block the outlet 42 of the bulkweigher 40 preventing substantially any crop material from being discharged from the bulkweigher 40 while the second gate 120 is in the closed position. In the open position, the second gate 120 is positioned so as to not block the outlet 42 of the bulkweigher 40 allowing crop material to be discharged out of the bulkweigher 40.

In one aspect, the second gate 120 can be provided on a pivot arm 122 and the second gate 120 moved by being pivoted on the pivot arm 122. In this manner, when the second gate 120 is pivoted to the open position the second gate 120 can be positioned substantially vertically to cause any crop material that has collected on top of the second gate 120 to fall into the conveyor 50, preventing any crop material from one load remaining on top of the second gate 120 and providing a self-cleaning effect.

By opening and closing the first gate 110 and the second gate 120 crop material being moved through the system 10 and loaded into an adjacent railroad car can be weighed by the bulkweighers 40. The first gate 110 can be placed in its closed position causing crop material being discharged out of a trailer or railroad car and into the garner 30 to collect in the garner 30. When the bulkweigher 40 is ready for weighing, the first gate 110 can be moved to the open position while the second gate 120 is in its closed position and crop material that has collected in the garner 30 discharged into the bulkweigher 40. When the bulkweigher 40 is full of crop material (this is typically determined by the weight of the crop material that is discharged in the bulkweigher 40 reaching a pre-set cutoff value), the first gate 110 can be moved back into the closed position to stop crop material from being discharged out of the garner 30. The weight of crop material in the bulkweigher 40 can then be taken and when this weight is determined (typically by subtracting the weight of the empty bulkweigher 40 from the weight of the loaded bulkweigher 40) the second gate 120 can be moved to the open position to discharge the crop material from the bulkweigher 40 out of the outlet 42. When all of the crop material has been discharged out of the bulkweigher 40, the second gate 120 can be once again be moved into the closed position and the first gate 110 moved to the open position to discharge crop material from the garner 30 into the bulkweigher 40. Crop material that has collected in the garner 30 while the previous batch of crop material was being weighed can then be discharged into the bulkweigher 40 to repeat the weighing process for the next batch of crop material.

When all of the crop material has passed through the bulkweigher 40, the weight determine for each batch of crop material can be added together to determine the total weight of the crop material that has passed through the bulkweigher 40.

In this manner, crop material being moved by the transload system 10 can be weighed as the crop material is being unloaded from a trailer or railroad car positioned on the trestle bridge 20.

Crop material that has been weighed and discharged from a bulkweigher 40 is directed into an inlet end 52 of one of the conveyors 50. A separate conveyor 50 can be provided for each of the bulkweighers 40 so that each bulkweigher 40 discharges crop material into a different conveyor 50.

The crop material can be discharged into the intake end 52 of the conveyor 50 where it will be lifted up the length of the conveyor 50 to the discharge end 54. In one aspect, the intake end 52 of the conveyor 50 can be positioned below the outlet 42 of bulkweigher 40 so that crop material discharged from the bulkweigher 40 can be gravity fed into the intake end 52 of the conveyor 50. The discharge end 54 can be positioned so that the discharge end 54 is provided overtop of a railroad car adjacent being loaded by the transloader system 10. The conveyors 50 can be any suitable conveyor, such as a paddle and chain conveyor, belt conveyor, bucket elevator, auger system, etc.

In one aspect, each conveyor 50 can have pneumatic cleaning system that will direct a blast of air at the discharge end 54 of the conveyor 50 providing a cleaning effect for the conveyor 50 to try and prevent any of the crop material remaining on the conveyor 50 rather than being discharged off the conveyor 50.

A spout 56 can be provided on the discharge end 54 of each conveyor 50 to help direct crop material being discharged out the discharge end 54 of the conveyor into the railroad car being loaded.

In one aspect, the railroad car being loaded may have a number of separate internal compartments. It is common for railroad cars to have four (4) separate internal compartments. The discharge end 54 of each conveyor 50 can be positioned so that each conveyor 50 is directing crop material to a different compartment in the railroad car. In this manner, a relatively exact weight of crop material loaded into each compartment in the railroad car can be determined because a single bulkweigher 40 will be used to load each separate compartment in the railroad car.

A hopper 60 can be provided between the outlet 42 of each bulkweigher 40 and the intake end 52 of the conveyor 50. The hopper 60 can act as a surge bin to provide a relatively steady flow of crop material to the conveyor 50 allowing crop material to collect in the hopper 60 when the bulkweigher 40 is discharging and providing a relatively steady stream of crop material to the conveyor 50 when the second gate 120 is in its closed position and the bulkweigher 40 is being used to measure the next batch of crop material.

The transload system 10 does not have to be used to load a railroad car positioned adjacent to the transload system 10. It is also contemplated that the transload system 10 could be used to load another truck and trailer, freight container, etc.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A system for weighing and loading particulate material while the particulate material is passing through the system, the system comprising:
a roadway;
an opening positioned in the roadway;
at least one bulkweigher provided below the opening, the at least one bulkweigher having an outlet; and
a conveyor having an intake end and a discharge end, the intake end of the conveyor positioned below outlet of the bulkweigher to receive particulate material that has been weighed by the bulkweigher and discharged from the bulkweigher.

2. The system of claim 1 wherein the bulkweighers weighs particulate material as it is being discharged and passing through the system.

3. The system of claim 1 wherein the at least one bulkweigher is gravity fed with particulate material discharged through the opening in the roadway.

4. The system of claim 1 further comprising a plurality of bulkweighers positioned below the opening and a garner connected to the opening, the garner positioned to direct particulate material discharged through the opening to the plurality of bulkweighers.

5. The system of claim 4 wherein there are a plurality of conveyors wherein each conveyor is associated with one of the bulkweighers so that a discharge end of the conveyor is positioned below the outlet of the associated bulkweigher.

6. The system of claim 1 wherein particulate material is gravity fed from the bulkweigher to the intake end of the conveyor.

7. The system of claim 1 further comprising a hopper positioned between the outlet of the bulkweigher and the intake end of the conveyor.

8. The system of claim 1 further comprising a garner positioned between the opening and the at least one bulkweigher to direct particulate material discharged into the opening into the bulkweigher.

9. The system of claim 8 further comprising a first gate positioned between the garner and the bulkweigher to control loading of the bulkweigher with particulate material being discharged through the opening.

10. The system of claim 9 wherein the first gate is operative to move between an open position, where particulate material is able to flow from the garner into the bulkweigher and a closed position, where the first gate substantially covers an outlet of the garner.

11. The system of claim 10 further comprising a second gate between the at least one bulkweigher and the conveyor to control discharge of particulate material from the bulkweigher.

12. The system of claim 9 wherein the first gate is positioned substantially vertically when the first gate is positioned in the open position.

13. The system of claim 11 wherein the second gate is positioned substantially vertically when the second gate is positioned in the open position.

14. The system of claim 11 wherein the bulkweigher is operative to weigh particulate material that is being discharged through the opening by:
placing the first gate in the open position while the second gate is in the closed position and allowing particulate material to be discharged into the bulkweigher;
after a period of time, placing the first gate in the closed position and using the bulkweigher to determine the weight of the particulate material in the bulkweigher;
after the weight of the particulate material in the bulkweigher has been determined, placing the second gate in the open position and allowing the particulate material to discharge out of the bulkweigher;
when the particulate material has been discharged out of the bulkweigher, placing then second gate in the closed position and, while the first gate is in the open position, allowing the particulate material to be discharged into the bulkweigher; and
when all of the particulate material has passed through the bulkweigher, adding all of the determined weights together to get a total weight of the particulate material that has passed through the bulkweigher.

15. The system of claim 1 wherein the at least one material conveyor is any one of: a paddle and chain conveyor; a belt conveyor; a bucket elevator; and a auger.

16. The system of claim 1 wherein the conveyor is configured to direct a blast of air at a discharge end of the conveyor.

17. The system of claim 1 wherein a spout is provided on the discharge end of the conveyor.

18. The system of claim 1 wherein a building is provided surrounding the roadway and the at least one bulkweigher.

19. The system of claim 1 wherein the roadway is supported by a trestle bridge.

20. The system of claim 1 wherein the roadway is provided at a ground level so that at least one of a vehicle; trailer or rail car can be moved off of the ground surface and onto the roadway for discharging a load into the opening in the roadway.

21. The system of claim 1 wherein railway tracks are recessed into a surface of the roadway.

22. A system for weighing and loading particulate material while the particulate material is passing through the system, the system comprising:
a roadway;
an opening positioned in the roadway;
a plurality of bulkweighers positioned below the opening and a garner connected to the opening, the garner positioned to direct particulate material discharged through the opening to the plurality of bulkweighers, bulkweigher having an outlet; and
a plurality of conveyors, each conveyor associated with one of the bulkweighers so that a discharge end of the material conveyor is positioned below the outlet of the associated bulkweigher to receive particulate material that has been weighed by the bulkweigher and discharged from the bulkweigher.

23. A method of simultaneously weighing and loading particulate material, the method comprising the steps of:
providing a roadway positioned above at least one bulkweigher,
providing an opening in the roadway;
positioning one of: a rail car; and a trailer above the opening in the roadway and discharging the particulate material through the opening into the at least one bulkweigher;
weighing the particulate material with the at least one bulkweigher as it is being discharged; and
after the particulate material has been weighed by the at least one bulkweigher, discharging the particulate material onto a conveyor and using the conveyor to load the particulate material into at least one of: an other railcar; and an other trailer.

24. The method of claim 23 wherein the at least one bulkweigher determines the weight of the particulate material being discharged by:
weighing a first batch of particulate material and then discharging the first batch of particulate material from the bulkweigher; weighing a next batch of particulate material before discharging the next batch of particulate material;
continuing to weight batches of particulate material until all of the particulate material has been discharged from the at least one of: the rail car; and the trailer; and,
when all of the particulate material has been discharged from the at least one of: the rail car; and the trailer, adding together the determined weight of each measure batch to determine a total weight of the particulate material.

25. The method of claim 23 wherein a plurality of bulkweighers are provided and further comprising directing the particulate material being discharged into the opening to each of the plurality of bulkweighers.

26. The method of claim 23 further providing a first gate positioned between the opening and the at least one bulkweigher and a second gate positioned at an outlet of the at least one bulkweigher.

27. The method of claim 23 wherein the at least one bulkweigher determines the weight of the particulate material being discharged by:
placing the first gate in an open position while the second gate is in a closed position and allowing particulate material to be discharged into the bulkweigher;
after a period of time, placing the first gate in a closed position and using the bulkweigher to determine the weight of the particulate material in the bulkweigher;
after the weight of the particulate material in the bulkweigher has been determined, placing the second gate in an open position and allowing the particulate material to discharge out of the bulkweigher;
when the particulate material has been discharged out of the bulkweigher, placing then second gate in the closed position and while the first gate in the open position, allowing particulate material to be discharged into the bulkweigher; and
when all of the particulate material has passed through the bulkweigher, adding all of the determined weights together to get a total weight of the particulate material that has passed through the bulkweigher.
